(19) United States
(12) Patent Application Publication
(10) Pub. No.: US 2025/0373291 A1
(43) Pub. Date: Dec. 4, 2025

(54) Statistical Precoding Design for Initial Downlink Transmissions

(71) Applicant: Dell Products L.P., Round Rock, TX (US)

(72) Inventors: Eran Goldstein, Montreal (CA); Jayaram Venguduswamy Srinivasan, Nepean (CA); Kazem Izadinasab, Kitchener (CA); Youqian Xiao, Toronto (CA)

(21) Appl. No.: 18/679,049

(22) Filed: May 30, 2024

(51) Int. Cl. H04B 7/0456; H04B 17/318

(52) U.S. Cl. CPC H04B 7/0478; H04B 17/328

(57) ABSTRACT

A system can collect respective measurements from respective user equipment that are in communication with a cell of a broadband cellular network. The system can determine a group of precoding matrices based on the respective measurements. The system can, before a user equipment attaching to the cell, select a precoding matrix from the group of precoding matrices for initial downlink transmission with the user equipment. The system can communicate with the user equipment based on the precoding matrix.

### BACKGROUND

A broadband cellular network can facilitate data transfer with user equipment (UE).

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can collect respective measurements from respective user equipment that are in communication with a cell of a broadband cellular network. The system can determine a group of precoding matrices based on the respective measurements. The system can, before a user equipment attaching to the cell, select a precoding matrix from the group of precoding matrices for initial downlink transmission with the user equipment. The system can communicate with the user equipment based on the precoding matrix.

An example method can comprise collecting, by a system comprising at least one processor, respective measurements from respective user equipment that are in communication with a cell of a broadband cellular network. The method can further comprise determining, by the system, a group of precoding matrices based on the respective measurements. The method can further comprise, before a user equipment attaches to the cell, selecting a precoding matrix from the group of precoding matrices. The method can further comprise, based on the user equipment being determined to have attached to the cell, communicating with the user equipment using the precoding matrix.

An example non-transitory computer-readable medium can comprise instructions that, in response to execution, cause a system comprising a processor to perform operations. These operations can comprise collecting respective measurements from respective devices that are in communication with a cell of a broadband cellular network. These operations can further comprise determining a group of precoding matrices based on the respective measurements. These operations can further comprise communicating with a device for initial downlink transmission using a precoding matrix that is selected from the group of precoding matrices before the device attaches to the system.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate statistical precoding design for initial downlink (DL) transmissions, in accordance with an embodiment of this disclosure;

FIG. 2 illustrates an example beam that can facilitate statistical precoding design for initial DL transmissions, in accordance with an embodiment of this disclosure;

FIG. 3 illustrates another example beam that can facilitate statistical precoding design for initial DL transmissions, in accordance with an embodiment of this disclosure;

FIG. 4 illustrates another example beam that can facilitate statistical precoding design for initial DL transmissions, in accordance with an embodiment of this disclosure;

FIG. 5 illustrates an example of aggregation levels that can facilitate statistical precoding design for initial DL transmissions, in accordance with an embodiment of this disclosure;

FIG. 6 illustrates an example process flow that can facilitate statistical precoding design for initial DL transmissions, in accordance with an embodiment of this disclosure;

FIG. 7 illustrates another example process flow that can facilitate statistical precoding design for initial DL transmissions, in accordance with an embodiment of this disclosure;

FIG. 8 illustrates another example process flow that can facilitate statistical precoding design for initial DL transmissions, in accordance with an embodiment of this disclosure;

FIG. 9 illustrates another example process flow that can facilitate statistical precoding design for initial DL transmissions, in accordance with an embodiment of this disclosure;

FIG. 10 illustrates an example process flow that can facilitate statistical precoding design for initial DL transmissions, in accordance with an embodiment of this disclosure;

FIG. 11 illustrates an example process flow that can facilitate statistical precoding design for initial DL transmissions, in accordance with an embodiment of this disclosure;

FIG. 12 illustrates an example process flow that can facilitate statistical precoding design for initial DL transmissions, in accordance with an embodiment of this disclosure;

FIG. 13 illustrates an example process flow that can facilitate statistical precoding design for initial DL transmissions, in accordance with an embodiment of this disclosure;

FIG. 14 illustrates an example block diagram of a computer operable to execute an embodiment of this disclosure.

### DETAILED DESCRIPTION

### Overview

The present examples generally relate to Fifth Generation New Radio (5G NR) cellular communications technologies. It can be appreciated that they can be applied to other types of communications technologies, such as Long-Term Evolution (LTE) or Sixth Generation (6G).

Initial transmissions in a cellular communication system can comprise the first transmissions a cell transmits to user equipment (UE) that is trying to connect to that cell. In this scenario, it can be that the cell does not have the channel information yet to decide which precoding is the optimal (or otherwise satisfactory; where an optimal approach is described herein, it can be appreciated that there can be examples of the present techniques where a satisfactory but non-optimal approach can also be used) precoding to the UE.

After the cell finishes the connection procedure, it can establish channel quality indicator (CQI) reports, which can provide the cell with the information to select an optimal precoding information. In addition, sounding reference signals (SRS) can be configured, and the uplink (UL) sounding information can be used to deduce (in the case of channel reciprocity) the optimal downlink (DL) precoding.

Since the channel can be unknown at the transmissions, it can be that it is not clear what is the optimal precoding across the cell antennas. It can be that a non-optimal precoding will lead to reduced utilization of a DL grid, e.g., lower throughput. In some cases, repeated transmissions can occur, leading to a reduction in the cell's throughput.

The present techniques can be implemented to address these problems.

According to the present techniques, a cell can find an optimal set of precoding vectors for the transmit (Tx) antennas, based on previous historical measurements.

An implementation of the present techniques can generally comprise:
1. The cell can collect (per UE) UL measurements and channel information reports from which an optimal Tx precoding can be found.
2. The cell can use the statistical information acquired in step 1 to derive a set of precoding matrixes that are most probable (or otherwise satisfactorily probably) to achieve high cell utilization. In some examples, the parameter to optimize can differ according to operator goals and cell.
3. The cell can use signs of UEs' misdetection of said initial DL transmissions (e.g., negative acknowledgment (NACK), and discontinuous transmission (DTX) signals from the UE) to update its statistical data of step 1.
4. The cell can repeat this process, to obtain up-to-date statistical data.
5. The cell can split a daily or weekly time frame to generate the correct statistical information per time period.
6. The cell can utilize artificial intelligence/machine learning (AI/ML) to achieve an optimal across the year learning of the optimal precoding vectors.

Prior approaches can generally have the following characteristics. In some cases, the cell can use multi-beam technology (in 5G NR) for its synchronization beams, and the other initial transmissions (e.g., physical downlink control channel (PDCCH), system information block (SIB), physical downlink shared change (PDSCH), and other SIBs) can be precoded (or beamformed) in the same manner as synchronization signal block (SSB) beams.

However, that approach can increase a layer 2 (L2) medium access control (MAC) layer load, so can be avoided in small and medium cells. In addition, that approach can ultimately use more resources over time, proportional to a number of used beams, to transmit the multiple beams and degrade the cell throughput.

Another prior approach can be to use only one antenna out of an antenna array (or, e.g., two antennas with a different polarization). This approach can create a large beam with a lower probability of null areas where reception is very low. A drawback can be that the Tx power can be reduced by 10*log 10(N_{used_antenna}/N_{total_antenna}), and the received power can be reduced up to 20*log 10(N_{used_antenna}/N_{total_antenna}) assuming coherent summation of signals, where _{used_antenna} and _{total_antenna} are respectively the number of used antennas and total number of transmit antennas.

For example, In the case of 4 antennas, there can be a 6 decibel (dB) Tx reduction if only 1 antenna is used, and up to 12 dB reduction in reception (Rx) power. Consequently, the cell range can be negatively impacted, or, more likely, the coding rate of those transmissions can decrease to compensate for the lower Tx power to restore the cell range. Therefore, a larger portion of the DL resource (DL grid) can be taken, which can again result in lower throughput.

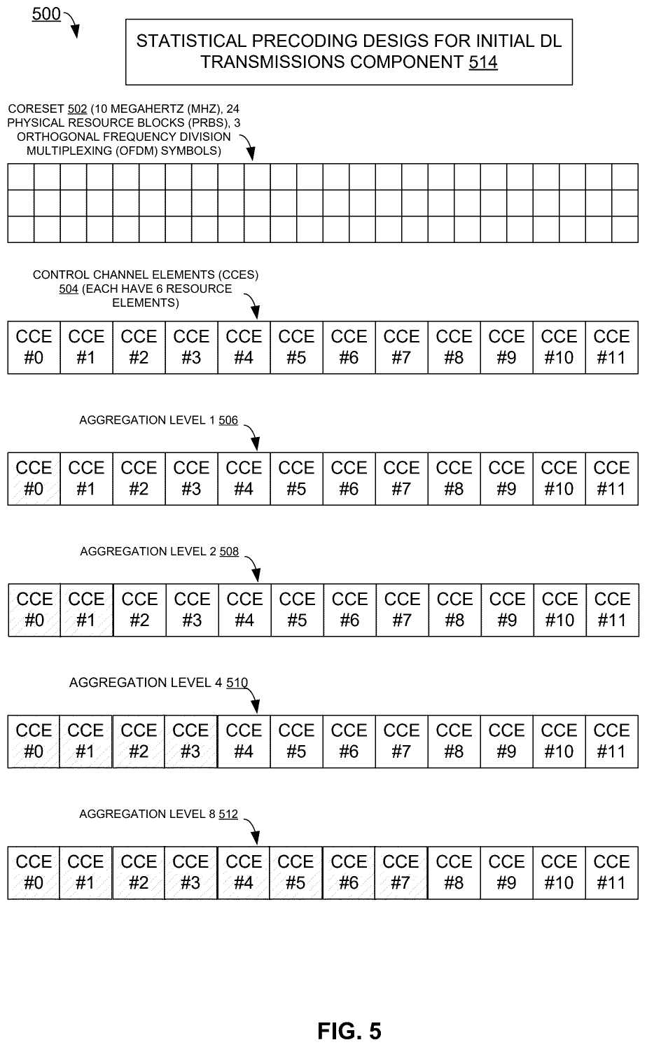

For example, for PDCCH, more resources can be required to accommodate repeating the payload to protect against an error, which can be known as aggregation level (AL) as shown in FIG. 5. As seen in this figure, for an aggregation level of 8, a control resource set (CORESET) with a length of 3 orthogonal frequency-division multiplexing (OFDM) symbols in the time domain can be required. However, even with a length of 3 OFDM symbols, it can be that an aggregation level of 16 cannot not be supported, limiting the cell range, and decoding of downlink control information (DCI), in some scenarios.

Similarly, in PDSCH transmission, the coding rate can be decreased by increasing a number of resources used to send it, resulting in a similar reduced spectral efficiency.

The present techniques can be implemented to address these problems with prior approaches by facilitating increasing DL spectral efficiency by reducing resources taken for initial DL transmissions, by optimal statistical precoding.

In some examples, this can benefit a cell with high mobility, where UEs spend less time in a cell, so therefore, the portion of time spent for initial DL transmissions can be higher compared to other scenarios.

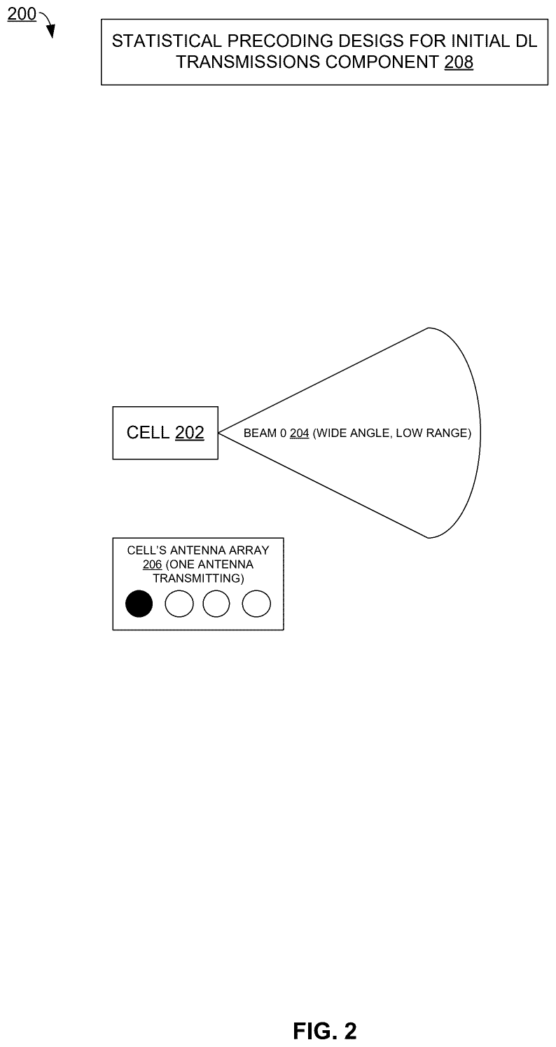

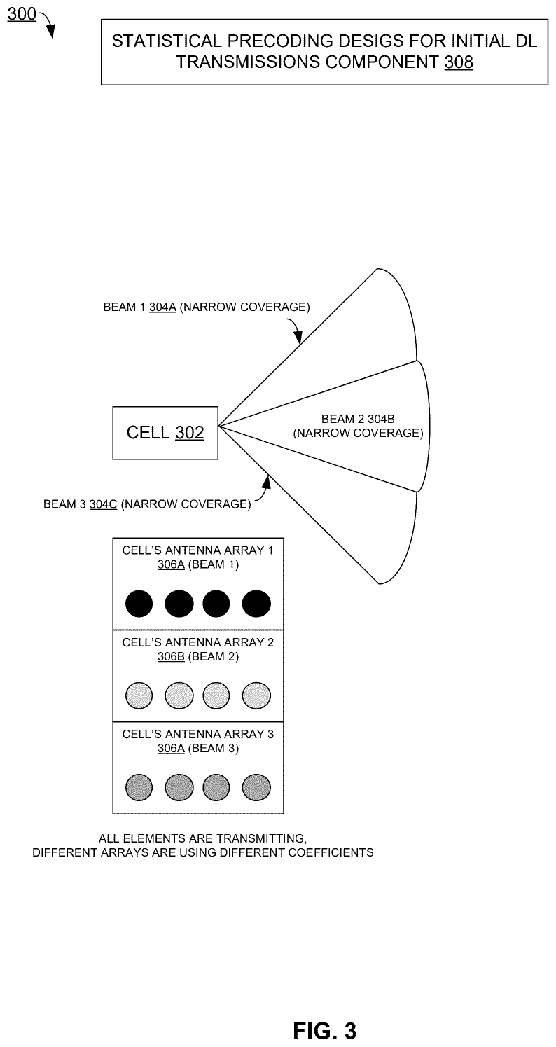

As seen in FIGS. 2-3, utilizing multiple elements of the antenna array can create lower angular coverage while improving signal strength. A problem can be that the location of the UE is unknown, and therefore utilizing a precoding scheme could reduce the signal quality. An alternative can be to use a wide beam generated by 1 array element; however, this can be suboptimal as the signal strength is reduced, and therefore more resource elements (REs) in a DL grid can be needed to ensure reception.

In general, an optimization problem to be addressed with the present techniques can involve minimizing an amount of the DL resources taken by the initial DL transmission by selecting an optimal precoding, while keeping the expected number of retransmissions for a corner case under a given value.

In different examples, this problem can be solved in different ways, including ML/AI approaches. In some examples, a relatively low-complexity approach can be taken.

Statistical data collection can be implemented as follows. According to the present techniques, a cell can collect information regarding an optimal DL precoding for all UEs, assuming 1 layer precoding.

A single layer precoding can be targeted since the initial DL transmissions of PDCCH. For initial PDSCH, while it can be that a number of layers is not specified in relevant standards, it can be that—in some examples—one-layer can be a proper choice since, if the UE is able to decode PDCCH with one layer it can be able to do so for one-layer PDSCH.

In some examples, data can be collected in one of the following ways:
1. Uplink control information (UCI): A UE can be configured to send a preferred precoding (which can exist in 5G NR standards). In addition, in a case where the UE reports back more than one precoding for multilayer massive multiple input multiple output (MIMO) transmission, it can be configured to also send the preferred single layer (which can exist in 5G NR standards).
2. SRS/demodulation reference signals (DMRS): In a case of channel UL-DL reciprocity, the UL reference signals can be used by the cell to estimate an optimal precoding for the UE.

In some examples, data can be collected in both of these ways, and the data can be merged.

There can be a predetermined list of possible precoding options. In some examples, this list can be derived from 3^{rd} Generation Partnership Project (3gpp) codebooks, or be enhanced to include a higher level of resolution (where 3gpp codebooks are heavily quantized).

Precoding selection according to a brute-force approach can be implemented as follows. A full-search brute-force approach can be implemented, which can be suitable in a case of a low number of predetermined beams to choose from.

In this approach, all or most of the relevant possible combinations of precodings can be checked for coverage. The approach can start at a minimum number of precodings, and increase a number if not all UEs receive sufficient coverage (where sufficient coverage can be defined according to a predetermined threshold value).

This approach can be implemented according to the following pseudocode:

```
  For number of precoding n_precoding = 1:N // N is the max number of
precoding to be transmitted
    Loop over all n_precoding combinations
      Are all UEs covered?
        If yes, store precoding _combination & stop_flag =1
        If there already exists a precoding _combination, compare and
      select the best.
    End
    If stop_flag==1, stop.
  End
```

If no beam_combination is found, the approach failed. Go back to the 1 antenna solution or the multi-beam solution.

Consider the following example implementation of this approach:
Assume no more than 2 precodings are desired, that is, N=2.
Assume there are 16 different predefined precoding to choose from.
For the outer loop (“Loop over all nprecoding combinations”), run—n_precoding=1—that is the check is whether only 1 precoding can cover all UEs.
   In the inner loop, check the coverage of all predefined 16 beams. If suitable coverage is found with any one of those precodings, the instance of the approach can be finished and the best precoding can be taken.
If none of the precoding covered all the UEs, the outer loop can run again with n_precoding=2.
   The inner loop will check all combinations, in this case (16*15)/2=120 of 2 precoding.
   If a suitable coverage with any one of those precoding combinations is found, the instance of the approach can be finished and the best precoding combination can be taken.
If no suitable precoding combination is found, the approach can end, and one of the existing solutions (e.g., SSB beams/single antenna) can be selected instead.

In some examples where a combination is precoded rather than determined at runtime, such a brute-force approach can offer a reasonable solution.

Usage of precodings can be implemented as follows. Initial DL transmissions can use the precoding combination to transmit the DL data.

A numerical ratio of usage of each precoding can be proportional to a ratio of number of UEs that are covered up to a ratio.

Consider the following example:
Assume in the previous stage a combination of 3 precodings were found to cover all UEs.
Assume the ratio of coverage (P_i) is: P_i=Ni/(N_UE); where Ni is the number of UEs covered by precoding I, and N_UE is the number of UEs.
The ratio of using precoding any one of the 3 selected precodings can be:

$$P\_i / ( P\_ 1 + P\_ 2 + P\_ 3 )$$

An opportunistic approach can be implemented for precoding selection. In some examples, this opportunistic approach can be implemented as an alternative to the brute-force approach above.

Data arrangement for an opportunistic approach can be implemented as follows. In a data arrangement stage, the data collected in a previous stage can be analyzed, for a purpose of finding a set of optimal precoding to be used—that is, P₁, P₂ . . . , Pp (where P indicates a precoding).

The different precodings can be organized in a histogram form, indicating how often each precodings is optimal, and how often it is sub-optimal for each UE in each measurement. In different examples, what is considered to be sub-optimal can vary. For example, a drop of between 3 to 6 dB (from optimal precodings—which can be a value that is defined by a user) can be considered sub-optimal, meaning the sub-optimal precoding can be considered to still be good compared to a wide beam, but not ideal.

A number of times the beam experiences a considerable drop of power for a specific UE can also be maintained. The data for the nulls can also contain the information regarding which beam would be optimal for those null cases.

| | | | | Null Beam List |
|---|---|---|---|---|
| Beam | | Sub - | | Idx of optimal and suboptimal |
| Idx | Optimal | Optimal | Null | of each null measurement |
| 1 | O₁ | S₁ | N₁ | L₁: List of all subsets of the beams |
| | | | | excluding beam index 1 |
| | | | | L₁ = {{2}, {3}, . . . , {P}, |
| | | | | {2, 3}, . . . , {2, 3, . . . , P}, { }} |
| | | | | {N_{1, j}}; j = 1, 2, . . . , 2^{P-1} |
| 2 | O₂ | S₂ | N₂ | L₂ |
| | | | | {N_{2, j}}; j = 1, 2, . . . , 2^{P-1} |
| 3 | O₃ | S₃ | N₃ | L₃ |
| | | | | {N_{3, j}}; j = 1, 2, . . . , 2^{P-1} |
| . . . | . . . | . . . | . . . | |
| P | O_{P} | S_{P} | N_{P} | L_{P} |
| | | | | {N_{P, j}}; j = 1, 2, . . . , 2^{P-1} |

In the above, the following terms are used:
K: A total number of measurement points belonging to M_{UE} (a total number of available UEs) such that M_{UE}≤K.
Oₚ: A number of measurements for which beam Index p has been optimal.
Sₚ: A number of measurements for which beam Index p has been sub-optimal.
Nₚ: A number of measurements for which beam index p has been null.
   Note that for a given beam index p, it can be that each measurement can contribute to only one of the values of Oₚ, Sₚ and Nₚ.
Lₚ: A list of all subsets of the beams, excluding beam index p; There can be 2^{P-1} such subsets, including the empty set.
Nₚⱼ: A counter corresponding to j-th subset of list Lₚ.

To implement the opportunistic approach, the following can be performed:
1. Set Oₚ, Sₚ, and Nₚ to zero for all beams p=1, 2, . . . , P.
2. Create list Lₚ for all beams p=1, 2, . . . , P, and set the corresponding counters N_{p,j}'s to zero.
3. For all measurement points k=1, 2, . . . , K, follow the below steps:
   a. Go over all the beam indices p=1, . . . , P.
      i. If beam index p is optimal, increment Oₚ by one.
      ii. If beam index p is sub-optimal, increment Sₚ by one.
      iii. If beam index p is null for the measurement point, increment Nₚ by one. Among other beams, find the ones that are optimal or sub-optimal for this null.
      iv. If subset j from Lₚ is the set of all beams that can cover the null measurement, increment the corresponding counter N_{p,j} by one. Note that if no other beam exists to cover the null, it can be that the empty subset is within the list and its respective counter is incremented by one.

In this opportunistic approach, the following can be true:
For each beam index p, Oₚ+Sₚ+Nₚ=K.
Lₚ can contain a list of beam subsets, excluding beam index p. For P available beams, the size of list Lₚ can be equal to 2^{P-1}, including the empty set. When incrementing the respective counter for each member of the list, the beams can need to be optimal or sub-optimal, but not below sub-optimal (as defined according to a criterion).
To avoid over emphasis of the same measurement, the list can reduce the samples from UEs that show lower mobility.

Beam selection can be implemented as follows. Based on the arrays collected in the stage above, the following steps can be executed to determine an optimal set of beams:
1. Set the selected beams set and their corresponding weights, denoted as S to { }.
2. Select the beam with the highest occurrence—that is, index m for which (Oₘ+Sₘ) is maximal and add this beam and weight qₘ=(Oₘ+Sₘ)/K to the selected beams list S. Therefore, S will be S={(Pₘ, qₘ)}.
3. Consider the null list corresponding to this selected beam, i.e., Lₘ.

$${max}_{j} {N}_{m , j} .$$

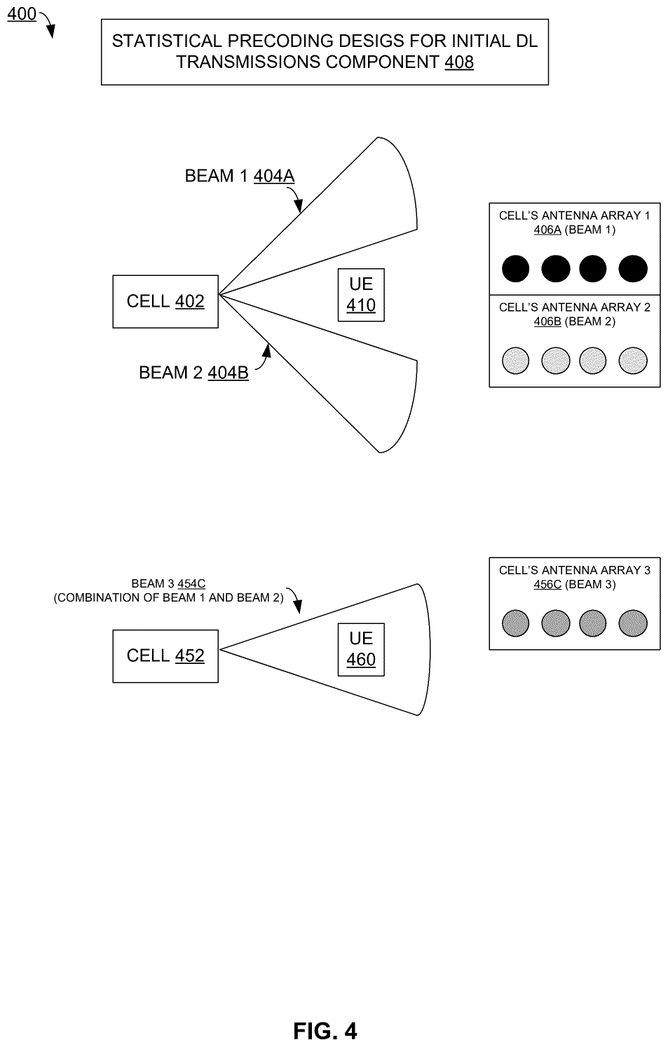

5. For all subsets within the list Lₘ for which the selected beam is a member with a non-zero counter, add the respective counter to N_{m,j}, then set the counter(s) to zero.
6. Update set S by adding this selected beam along with the weight N_{m,j}/K. Then set N_{m,j} to zero.
7. If there is no non-zero counter N_{m,j} (implying no more nulls exist), or the counter corresponding to the empty set is the only non-zero counter (implying the nulls cannot be covered by the available beam), go to step 8. Otherwise go back to step 4.
8. This step can be optional in some examples. If the counter corresponding to the empty set is the only non-zero counter (implying that there is a null that cannot be covered by the available beams), a combination of more than one beam can be used to cover such nulls (see FIG. 4). Create a beam that can cover most (or all) nulls, and add the beam and the respective weight (number of covered beams/K) to the selected beams list S. Continue Step 8 until there are no more nulls.
9. Use the precoding set determined above, not with equal probability, but with the same occurrence rate added to set S.

The following example can illustrate this approach. Assume that there are three available beams (that is, P=3), and 1,000 measurements belonging to some UEs. The data arrangement for these UEs and measurements in this example are given in the following table.

| Beam | | Sub- | | |
|---|---|---|---|---|
| Idx | Optimal | Optimal | Null | Null List |
| 1 | 700 | 100 | 200 | L₁ = {{2}, {3}, {2, 3}, { }} |
| | | | | Counter = {100, 50, 25, 25} |
| 2 | 100 | 400 | 500 | L₂ = {{1}, {3}, {1, 3}, { }} |
| | | | | Counter = {425, 50, 0, 25} |
| 3 | 50 | 25 | 925 | L₃ = {{1}, {2}, {1, 2}, { }} |
| | | | | Counter = {425, 140, 375, 25} |

Using this example, beam selection can be performed as follows:
1. SetS={ }.
2. Beam index 1 with O₁+S₁=800 is selected as the most occurrent beam. This beam along with its weight (800/1000=0.8), is added to set S. Hence, S={(P1, 0.8)}.
3. There are 200 nulls associated with this beam. Consider the null list L₁={{2}, {3}, {2,3}, { }} and their respective counters {N_{1,1}, N_{1,2}, N_{1,3}, N_{1,4}}.
4. Beam index 2 with a counter of N_{1,4}=140 can cover most of the nulls.
5. Since beam index 2 also exists in subset {2,3}, update N_{1,4} by adding N_{1,3} to it. The updated counters are {N_{1,1}, N_{1,2}, N_{1,3}, N_{1,4}}={125, 50, 0, 25}.
6. Update S by adding beam index 2 and its corresponding weight (125/1000=0.125). S can be S={(P1, 0.8), (P2, 0.125)}. By setting N_{1,1} to zero, the updated counters are {N_{1,1}, N_{1,2}, N_{1,3}, N_{1,4}}={0, 50, 0, 25}.
7. Select beam index 3 with non-zero counter of N_{1,2}=50. This beam index is not a member of other subsets with non-zero counters. Hence, this beam index (with its weight of 50/1000) is added to set S. S will be S={(P1, 0.8), (P2, 0.125), (P3, 0.05)}. Now set N_{1,2}=0. The updates counters are {N_{1,1}, N_{1,2}, N_{1,3}, N_{1,4}}={0, 0, 0, 25}.
8. Since the only remaining non-zero counter belongs to nulls that cannot be covered by the beam indices 1-3, a new beam can be generated for such nulls. Assume that a new beam with index 4 will cover all of these nulls. This new beam with its respective weight of 25/1000 is added to set S.
9. The precoding set with its associated weights will be S={(P1, 0.8), (P2, 0.125), (P3, 0.05), (P4, 0.025)}.

Frequency selectivity can be implemented as follows. As the optimal precodings can be different per frequency sub-band, the approach above could be repeated per each sub-band.

Failure as feedback can be addressed as follows. If DL transmission failure is discoverable by the cell (NACK or DTX), they can be used to update the statistics. Such events can be used by the cell as a trigger to start the approach above.

That is, if in a period T, a larger number than the threshold N events of NACKs or DTX occurred over the existing selected precodings, the cell can rerun the approaches described above to find the new precoding(s).

T and N can be left as parameters in the algorithm.

In different examples, data that is used can be new or a combination of the old UEs reports and new reports.

Time dependent precoding selection can be implemented as follows. A cell can split a daily or weekly time frame to generate the correct statistical information per time period.

A cell can utilize AI/ML to achieve an optimal across the year learning of optimal precoding vectors.

### Example Architectures, Etc.

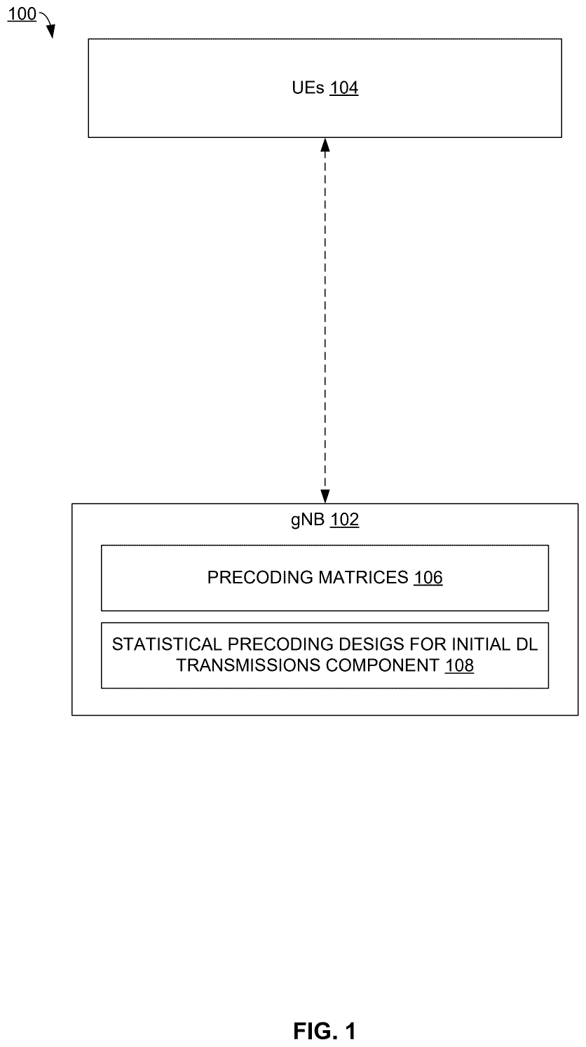

FIG. 1 illustrates an example system architecture 100 that can facilitate statistical precoding design for initial DL transmissions, in accordance with an embodiment of this disclosure.

System architecture 100 comprises gNodeB (gNB) 102 and UEs 104. In turn, gNB 102 comprises precoding matrices 106, and statistical precoding design for initial DL transmissions component 108.

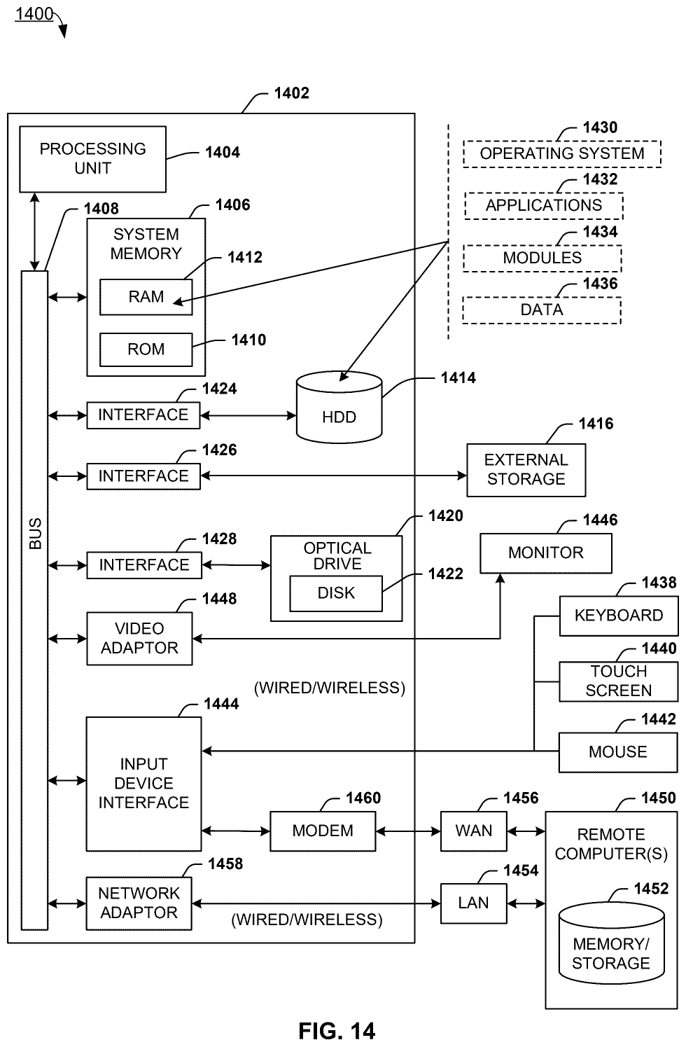

Each of gNB 102 and/or UEs 104 can be implemented with part(s) of computing environment 1400 of FIG. 14.

gNB 102 (sometimes referred to as a cell) can communicate with UEs 104, and in doing so determine statistics regarding the operations of UEs 104. Statistical precoding design for initial DL transmissions component 108 can use these statistics to determine precoding matrices 106. Then, when a UE of UEs 104 attaches to gNB 102, statistical precoding design for initial DL transmissions component 108 can use a predetermined precoding of precoding matrices 106 for initial DL transmissions between gNB 102 and the UE of UEs 104.

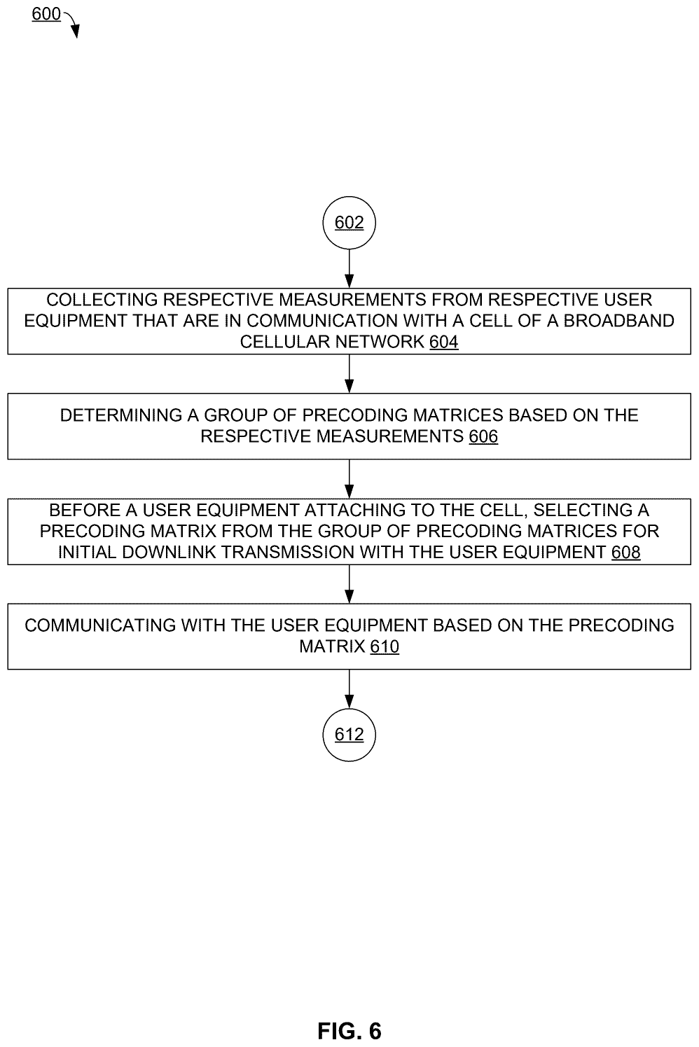

In some examples, statistical precoding design for initial DL transmissions component 108 can implement part(s) of the process flows of FIGS. 6-13 to facilitate statistical precoding design for initial DL transmissions.

It can be appreciated that system architecture 100 is one example system architecture for proactive prevention of data unavailability and data loss, and that there can be other system architectures that facilitate statistical precoding design for initial DL transmissions.

FIG. 2 illustrates an example 200 of a beam that can facilitate statistical precoding design for initial DL transmissions, in accordance with an embodiment of this disclosure. In some examples, part(s) of example 200 can be implemented by part(s) of system architecture 100 of FIG. 1 to facilitate statistical precoding design for initial DL transmissions.

Example 200 comprises cell 202, beam 0 204 (wide angle, low range), cell's antenna array 206 (one antenna transmitting), and statistical precoding design for initial DL transmissions component 208 (which can be similar to statistical precoding design for initial DL transmissions component 108 of FIG. 1).

In FIG. 2, beam 0 204 is created by utilizing one element of cell's antenna array 206, which can create a wide but weak beam. An impact of precoding on coverage can relate to narrow beams providing stronger signals in their coverage and can reach longer distances, but have a lower angular coverage.

FIG. 3 illustrates another example 300 of a beam that can facilitate statistical precoding design for initial DL transmissions, in accordance with an embodiment of this disclosure. In some examples, part(s) of example 300 can be implemented by part(s) of system architecture 100 of FIG. 1 to facilitate statistical precoding design for initial DL transmissions.

Example 300 comprises cell 302, beam 1 304A (narrow coverage), beam 2 304B (narrow coverage), beam 3 304C (narrow coverage), cell's antenna array 1 306A (beam 1), cell's antenna array 2 306B (beam 2), cell's antenna array 3 306A (beam 3), and statistical precoding design for initial DL transmissions component 308 (which can be similar to statistical precoding design for initial DL transmissions component 108 of FIG. 1).

FIG. 3 illustrates an impact of utilizing multiple elements in an array with different precoding coefficients on coverage. A narrow beam can provide stronger signals in their coverage and can reach longer distances, but have a lower angular coverage.

FIG. 4 illustrates another example 400 of a beam that can facilitate statistical precoding design for initial DL transmissions, in accordance with an embodiment of this disclosure. In some examples, part(s) of example 400 can be implemented by part(s) of system architecture 100 of FIG. 1 to facilitate statistical precoding design for initial DL transmissions.

Example 400 comprises cell 402, beam 1 404A, beam 2 404B, cell's antenna array 1 406A (beam 1), cell's antenna array 2 406B (beam 2), statistical precoding design for initial DL transmissions component 408 (which can be similar to statistical precoding design for initial DL transmissions component 108 of FIG. 1), UE 410, cell 452, beam 3 454C (combination of beam 1 and beam 2), cell's antenna array 3 456C (beam 3), and UE 460.

In general, cell 402, beam 1 404A, beam 2 404B, cell's antenna array 1 406A (beam 1), cell's antenna array 2 406B (beam 2), and UE 410 can represent one configuration of a cell and a UE. And cell 452, beam 3 454C (combination of beam 1 and beam 2), cell's antenna array 3 456C (beam 3), and UE 460 can represent another configuration of that cell and that UE.

FIG. 4 illustrates an example where, if a UE cannot be covered using each of the available beams, then a combination of more than one beam can cover the UE (sometimes referred to as a null, in terms of beam coverage). In the example of FIG. 4, the UE is covered with beam 3 454C, which is a combination of beam 1 404A and beam 2 404B.

FIG. 5 illustrates an example 500 of aggregation levels that can facilitate statistical precoding design for initial DL transmissions, in accordance with an embodiment of this disclosure. In some examples, part(s) of example 500 can be implemented by part(s) of system architecture 100 of FIG. 1 to facilitate statistical precoding design for initial DL transmissions.

Example 500 comprises coreset 502 (10 megahertz (MHz), 24 physical resource blocks (PRBs), 3 orthogonal frequency division multiplexing (OFDM) symbols), control channel elements (CCEs) 504, aggregation level 1 506, aggregation level 2 508, aggregation level 4 510, aggregation level 8 512, and statistical precoding design for initial DL transmissions component 514 (which can be similar to statistical precoding design for initial DL transmissions component 108 of FIG. 1).

Different aggregation levels can be selected by a gNB for DCI to adjust a code rate. Coreset 502 (10 megahertz (MHz), 24 physical resource blocks (PRBs), 3 orthogonal frequency division multiplexing (OFDM) symbols), control channel elements (CCEs) 504, aggregation level 1 506, aggregation level 2 508, aggregation level 4 510, aggregation level 8 512, and statistical precoding design for initial DL transmissions component 514 (which can be similar to statistical precoding design for initial DL transmissions component 108 of FIG. 1). Different aggregation levels can be selected by a gNB for DCI to adjust a code rate.

### Example Process Flows

FIG. 6 illustrates an example process flow 600 for statistical precoding design for initial DL transmissions, in accordance with an embodiment of this disclosure. In some examples, one or more embodiments of process flow 600 can be implemented by system architecture 100 of FIG. 1, or computing environment 1400 of FIG. 14.

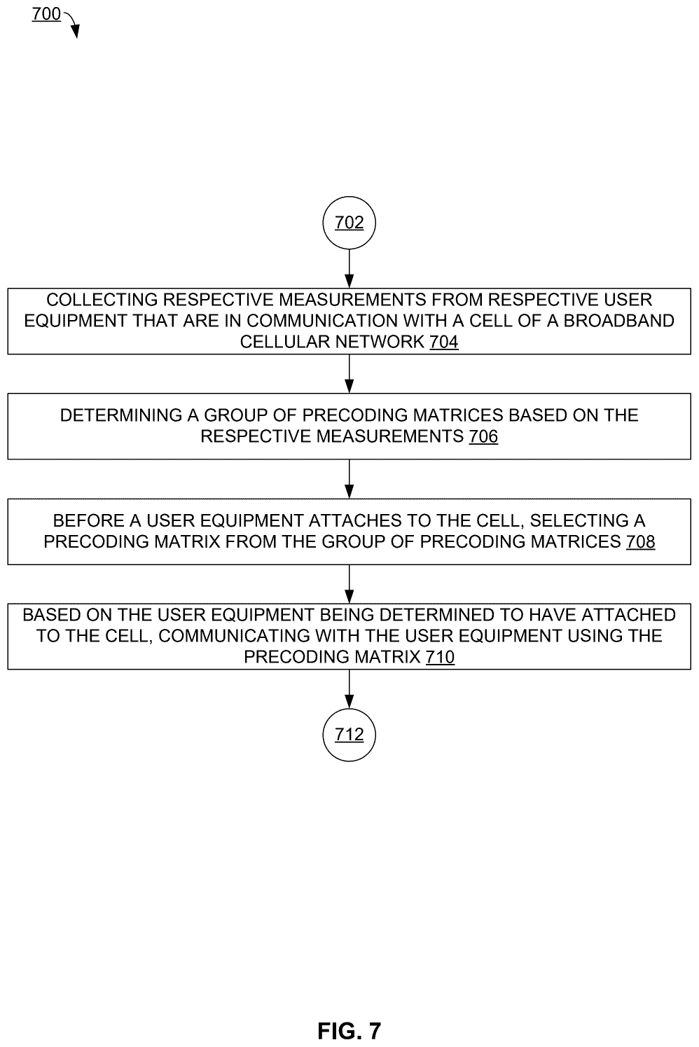

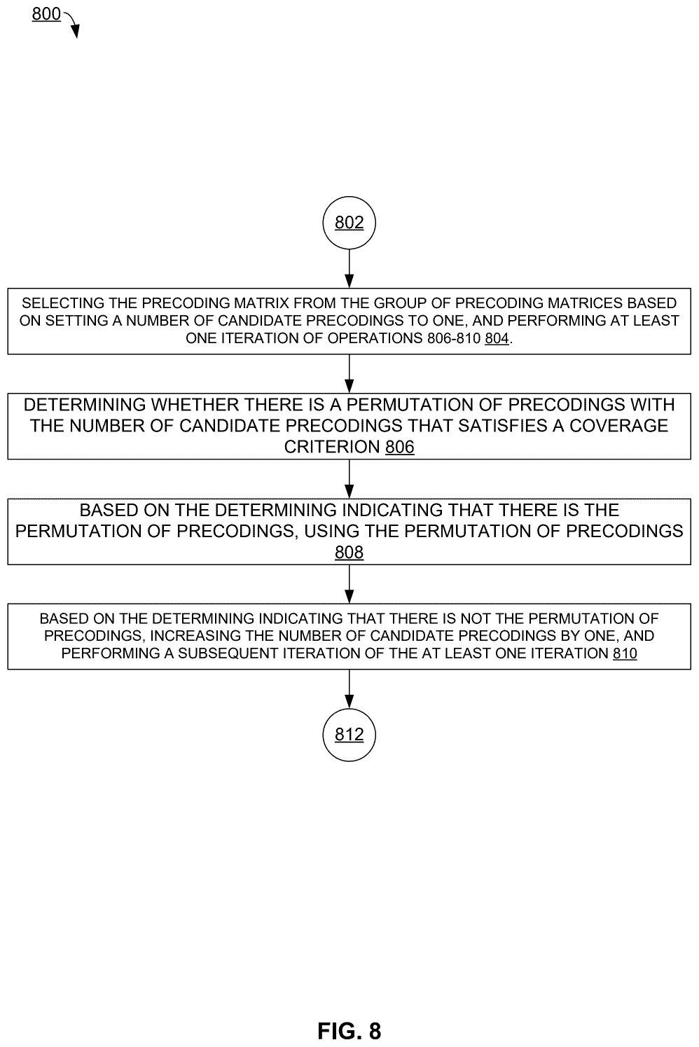

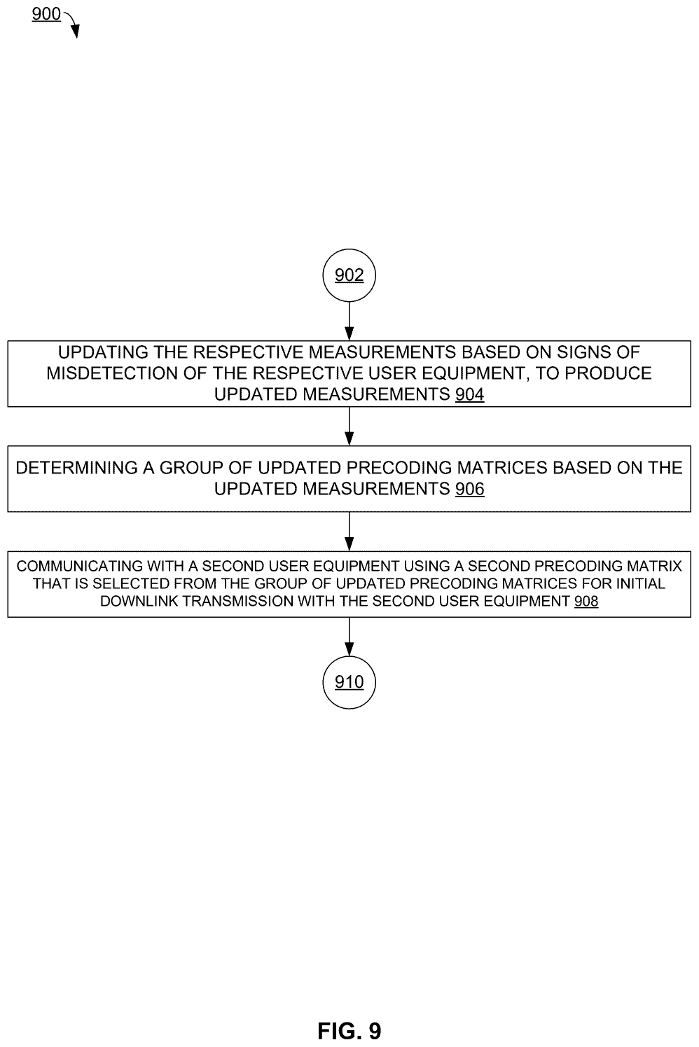

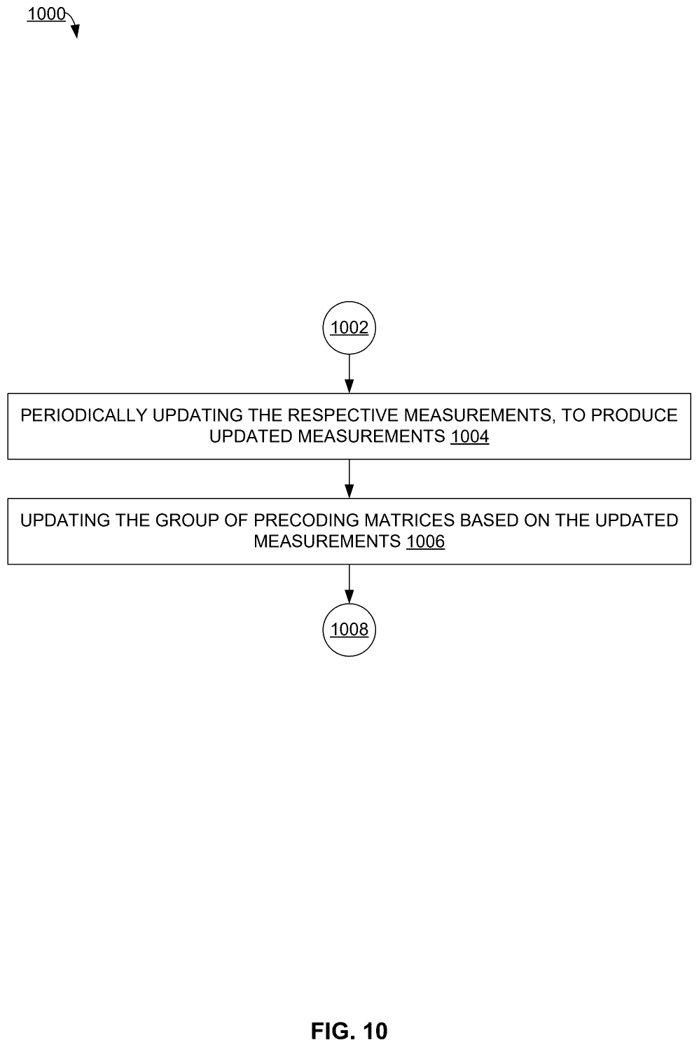

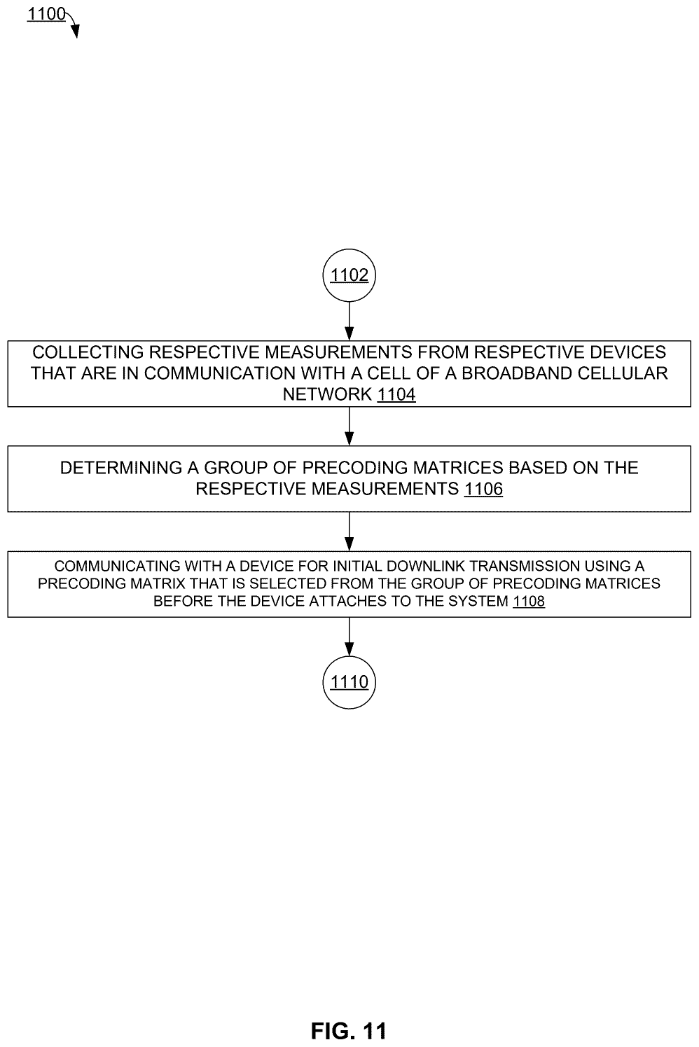

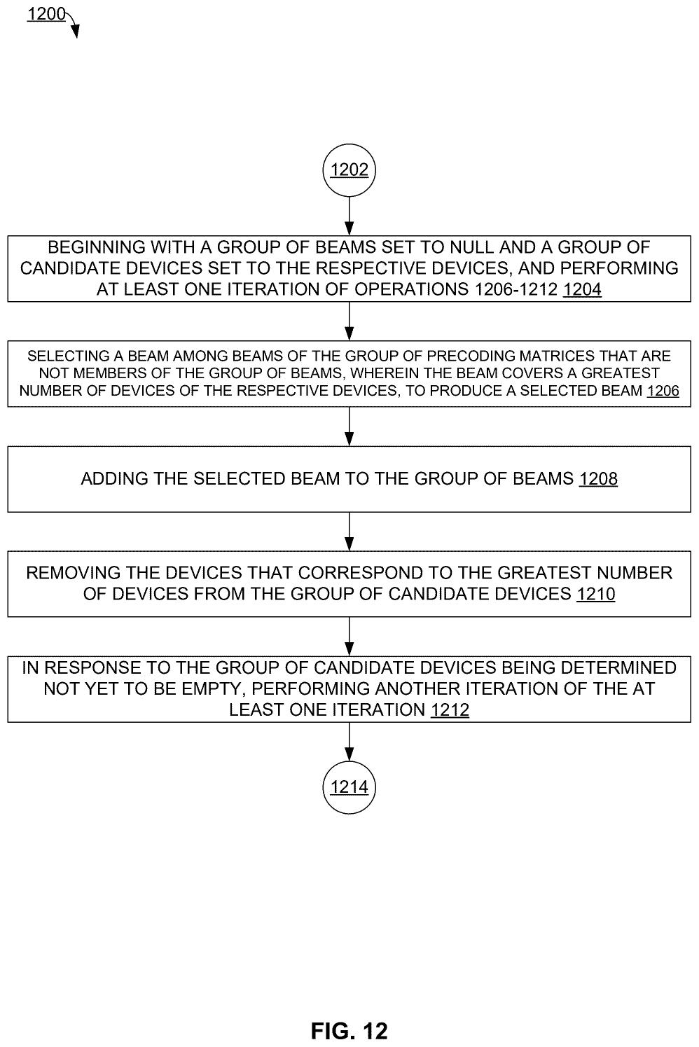

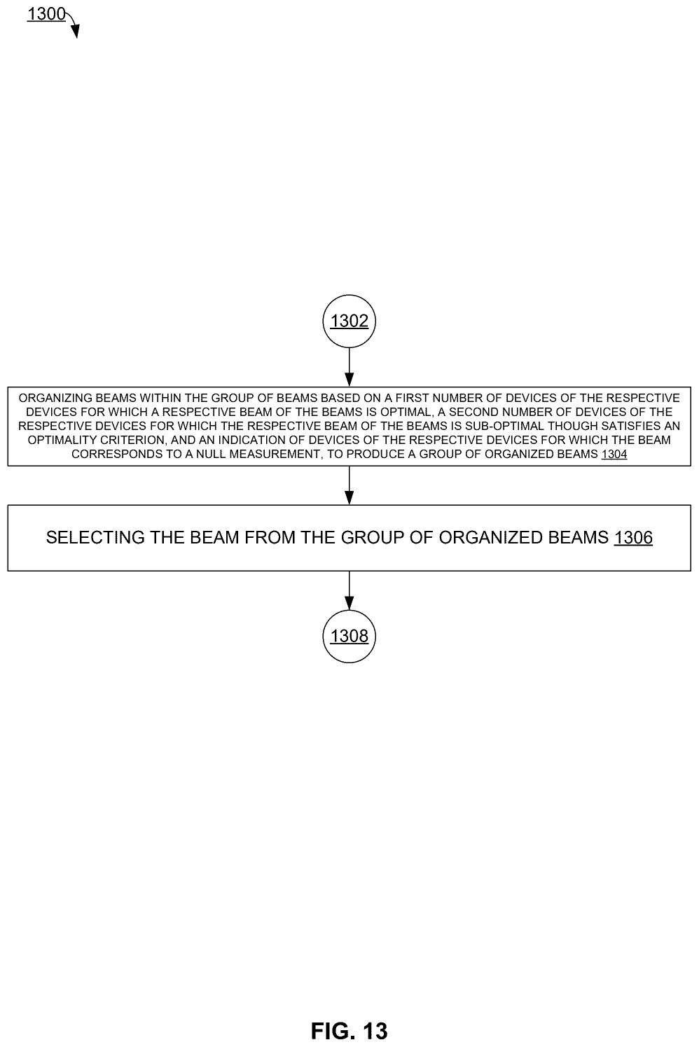

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 700 of FIG. 7, process flow 800 of FIG. 8, process flow 900 of FIG. 9, process flow 1000 of FIG. 10, process flow 1100 of FIG. 11, process flow 1200 of FIG. 12, and/or process flow 1300 of FIG. 13.

Process flow 600 begins with 602, and moves to operation 604.

Operation 604 depicts collecting respective measurements from respective user equipment that are in communication with a cell of a broadband cellular network. That is, a cell can collect (per UE) UE measurements and channel information reports.

In some examples, the respective measurements comprise respective uplink control information measurements. In some examples, the user equipment is first user equipment, a second user equipment of the respective user equipment is configured to communicate with the cell via a multiple input multiple output antenna configuration, and information about a single layer precoding is received from the second user equipment. That is, a UE can be configured to send a preferred precoding (which can exist in 5G NR standards). In addition, in a case where the UE reports back more than one precoding for multilayer massive multiple input multiple output (MIMO) transmission, it can be configured to also send the preferred single layer (which can exist in 5G NR standards).

In some examples, the respective measurements comprise respective sounding reference signal measurements. In some examples, the respective sounding reference signal measurements are collected based on channel uplink-downlink reciprocity being enabled for communications with at least some of the respective user equipment. That is, in a case of channel UL-DL reciprocity, the UL reference signals can be used by a cell to estimate an optimal precoding for the UE.

In some examples, the respective measurements comprise respective demodulation reference signal measurements.

In some examples, the respective measurements comprise a first combination of respective uplink control information measurements and respective sounding reference signal measurements, or a second combination of respective uplink control information measurements and respective demodulation reference signal measurements. That is, a combination of UCI and SRS/DMRS information can be used.

After operation 604, process flow 600 moves to operation 606.

Operation 606 depicts determining a group of precoding matrices based on the respective measurements. That is, the cell can use this information to derive a set of precoding matrixes that can be most probable (or probable) to achieve high cell utilization.

After operation 606, process flow 600 moves to operation 608.

Operation 608 depicts, before a user equipment attaching to the cell, selecting a precoding matrix from the group of precoding matrices for initial downlink transmission with the user equipment. That is, a cell can pre-select a precoding for a UE for its initial DL transmission based on the information from operations 604-606.

In some examples, beam selection can be performed offline and based on measurements of a group of UEs. Then, the beams can be utilized for existing and new UEs within a cell. So, it can be that a beam is determined for a particular UE before that UE attaches to the cell.

After operation 608, process flow 600 moves to operation 610.

Operation 610 depicts communicating with the user equipment based on the precoding matrix. That is, the precoding of operation 608 can be used for initial DL transmissions with the UE.

After operation 610, process flow 600 moves to 612, where process flow 600 ends.

FIG. 7 illustrates an example process flow 700 for statistical precoding design for initial DL transmissions, in accordance with an embodiment of this disclosure. In some examples, one or more embodiments of process flow 700 can be implemented by system architecture 100 of FIG. 1, or computing environment 1400 of FIG. 14.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 600 of FIG. 6, process flow 800 of FIG. 8, process flow 900 of FIG. 9, process flow 1000 of FIG. 10, process flow 1100 of FIG. 11, process flow 1200 of FIG. 12, and/or process flow 1300 of FIG. 13.

Process flow 700 begins with 702, and moves to operation 704.

Operation 704 depicts collecting respective measurements from respective user equipment that are in communication with a cell of a broadband cellular network. In some examples, operation 704 can be implemented in a similar manner as operation 604 of FIG. 6.

After operation 704, process flow 700 moves to operation 706.

Operation 706 depicts determining a group of precoding matrices based on the respective measurements. In some examples, operation 706 can be implemented in a similar manner as operation 606 of FIG. 6.

After operation 706, process flow 700 moves to operation 708.

Operation 708 depicts, before a user equipment attaches to the cell, selecting a precoding matrix from the group of precoding matrices. In some examples, operation 708 can be implemented in a similar manner as operation 608 of FIG. 6.

After operation 708, process flow 700 moves to operation 710.

Operation 710 depicts based on the user equipment being determined to have attached to the cell, communicating with the user equipment using the precoding matrix. In some examples, operation 710 can be implemented in a similar manner as operation 610 of FIG. 6.

After operation 710, process flow 700 moves to 712, where process flow 700 ends.

FIG. 8 illustrates an example process flow 800 for statistical precoding design for initial DL transmissions, in accordance with an embodiment of this disclosure. In some examples, one or more embodiments of process flow 800 can be implemented by system architecture 100 of FIG. 1, or computing environment 1400 of FIG. 14.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 600 of FIG. 6, process flow 700 of FIG. 7, process flow 900 of FIG. 9, process flow 1000 of FIG. 10, process flow 1100 of FIG. 11, process flow 1200 of FIG. 12, and/or process flow 1300 of FIG. 13.

Process flow 800 begins with 802, and moves to operation 804.

Operation 804 depicts selecting the precoding matrix from the group of precoding matrices based on setting a number of candidate precodings to one, and performing at least one iteration of operations 806-810.

That is, precoding selection according to a brute-force approach can be implemented. A full-search brute-force approach can be implemented, which can be suitable in a case of a low number of predetermined beams to choose from. In this approach, all or most of the relevant possible combinations of precodings can be checked for coverage. The approach can start at a minimum number of precodings, and increase a number if not all UEs receive sufficient coverage (where sufficient coverage can be defined according to a predetermined threshold value). Precoding selection according to a brute-force approach can be implemented as follows. A full-search brute-force approach can be implemented, which can be suitable in a case of a low number of predetermined beams to choose from.

In this approach, all or most of the relevant possible combinations of precodings can be checked for coverage. The approach can start at a minimum number of precodings, and increase a number if not all UEs receive sufficient coverage (where sufficient coverage can be defined according to a predetermined threshold value).

After operation 804, process flow 800 moves to operation 806.

Operation 806 depicts determining whether there is a permutation of precodings with the number of candidate precodings that satisfies a coverage criterion.

After operation 806, process flow 800 moves to operation 808.

Operation 808 depicts, based on the determining indicating that there is the permutation of precodings, using the permutation of precodings.

After operation 808, process flow 800 moves to operation 810.

Operation 810 depicts, based on the determining indicating that there is not the permutation of precodings, increasing the number of candidate precodings by one, and performing a subsequent iteration of the at least one iteration. This can be the iteration of operations 808-810.

In some examples, operation 810 comprises, based on determining that no permutation of precodings satisfies the coverage criterion for any value of the number of candidate precodings, communicating with the user equipment using a currently-used precoding. That is, if no suitable precoding combination is found, the approach can end, and one of the existing solutions (e.g., SSB beams/single antenna) can be selected instead.

After operation 810, process flow 800 moves to 812, where process flow 800 ends.

FIG. 9 illustrates an example process flow 900 for statistical precoding design for initial DL transmissions, in accordance with an embodiment of this disclosure. In some examples, one or more embodiments of process flow 900 can be implemented by system architecture 100 of FIG. 1, or computing environment 1400 of FIG. 14.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 600 of FIG. 6, process flow 700 of FIG. 7, process flow 800 of FIG. 8, process flow 1000 of FIG. 10, process flow 1100 of FIG. 11, process flow 1200 of FIG. 12, and/or process flow 1300 of FIG. 13.

Process flow 900 begins with 902, and moves to operation 904.

In some examples where process flow 900 is implemented in conjunction with process flow 700, the user equipment is a first user equipment, and the precoding matrix is a first precoding matrix.

Operation 904 depicts updating the respective measurements based on signs of misdetection of the respective user equipment, to produce updated measurements.

In some examples, the signs of misdetection comprise a negative acknowledgment, or a discontinuous transmission indication. That is, the signs of misdetection can comprise signs of UEs' misdetection of initial DL transmissions (e.g., NACK and/or DTX signals from the UE).

After operation 904, process flow 900 moves to operation 906.

Operation 906 depicts determining a group of updated precoding matrices based on the updated measurements. That is, a cell can update its statistical information based on the updating of operation 904.

After operation 906, process flow 900 moves to operation 908.

Operation 908 depicts communicating with a second user equipment using a second precoding matrix that is selected from the group of updated precoding matrices for initial downlink transmission with the second user equipment. That is, the cell can use its updated precodings for initial DL transmissions.

After operation 908, process flow 900 moves to 910, where process flow 900 ends.

FIG. 10 illustrates an example process flow 1000 for statistical precoding design for initial DL transmissions, in accordance with an embodiment of this disclosure. In some examples, one or more embodiments of process flow 1000 can be implemented by system architecture 100 of FIG. 1, or computing environment 1400 of FIG. 14.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 600 of FIG. 6, process flow 700 of FIG. 7, process flow 800 of FIG. 8, process flow 900 of FIG. 9, process flow 1100 of FIG. 11, process flow 1200 of FIG. 12, and/or process flow 1300 of FIG. 13.

Process flow 1000 begins with 1002, and moves to operation 1004.

Operation 1004 depicts periodically updating the respective measurements, to produce updated measurements. That is, a cell can periodically, repeatedly, and/or iteratively update its statistical data.

In some examples, the periodic updating of the respective measurements is performed according to a defined time period. That is, the updating can be performed according to a time period, such as daily, weekly, or monthly.

After operation 1004, process flow 1000 moves to operation 1006.

Operation 1006 depicts updating the group of precoding matrices based on the updated measurements. That is, a cell can periodically, repeatedly, and/or iteratively update its precoding matrices based on the updated statistical data of operation 1004.

In some examples, the updating is performed using an output from a trained artificial intelligence/machine learning (AI/ML) model. That is, an AI/ML model can be implemented to determine optimal (or satisfactory) precoding matrices (or vectors).

After operation 1006, process flow 1000 moves to 1008, where process flow 1000 ends.

FIG. 11 illustrates an example process flow 1100 for statistical precoding design for initial DL transmissions, in accordance with an embodiment of this disclosure. In some examples, one or more embodiments of process flow 1100 can be implemented by system architecture 100 of FIG. 1, or computing environment 1400 of FIG. 14.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 600 of FIG. 6, process flow 700 of FIG. 7, process flow 800 of FIG. 8, process flow 900 of FIG. 9, process flow 1000 of FIG. 10, process flow 1200 of FIG. 12, and/or process flow 1300 of FIG. 13.

Process flow 1100 begins with 1102, and moves to operation 1104.

Operation 1104 depicts collecting respective measurements from respective devices that are in communication with a cell of a broadband cellular network. In some examples, operation 1104 can be implemented in a similar manner as operation 604 of FIG. 6.

After operation 1104, process flow 1100 moves to operation 1106.

Operation 1106 depicts determining a group of precoding matrices based on the respective measurements. In some examples, operation 1106 can be implemented in a similar manner as operation 606 of FIG. 6.

In some examples, the group of precoding matrices is a first group of precoding matrices, the first group of precoding matrices is determined for a first frequency sub-band, and operation 1106 comprises determining a second group of precoding matrices for a second frequency sub-band. That is, precodings can be different per frequency sub-band, and can be determined for multiple sub-bands.

After operation 1106, process flow 1100 moves to operation 1108.

Operation 1108 depicts communicating with a device for initial downlink transmission using a precoding matrix that is selected from the group of precoding matrices before the device attaches to the system. In some examples, operation 1108 can be implemented in a similar manner as operations 608-610 of FIG. 6.

After operation 1108, process flow 1100 moves to 1110, where process flow 1100 ends.

FIG. 12 illustrates an example process flow 1200 for statistical precoding design for initial DL transmissions, in accordance with an embodiment of this disclosure. In some examples, one or more embodiments of process flow 1200 can be implemented by system architecture 100 of FIG. 1, or computing environment 1400 of FIG. 14.

It can be appreciated that the operating procedures of process flow 1200 are example operating procedures, and that there can be embodiments that implement more or fewer operating procedures than are depicted, or that implement the depicted operating procedures in a different order than as depicted. In some examples, process flow 1200 can be implemented in conjunction with one or more embodiments of one or more of process flow 600 of FIG. 6, process flow 700 of FIG. 7, process flow 800 of FIG. 8, process flow 900 of FIG. 9, process flow 1000 of FIG. 10, process flow 1100 of FIG. 11, and/or process flow 1300 of FIG. 13.

Process flow 1200 begins with 1202, and moves to operation 1204.

In some examples, process flow 1200 can be implemented to facilitate selecting the precoding matrix from the group of precoding matrices, as in operation 908 of FIG. 9.

Operation 1204 depicts beginning with a group of beams set to null and a group of candidate devices set to the respective devices, and performing at least one iteration of operations 1206-1212. Operations 1204-1212 can together comprise beam selection for an opportunistic technique, as described herein.

After operation 1204, process flow 1200 moves to operation 1206.

Operation 1206 depicts selecting a beam among beams of the group of precoding matrices that are not members of the group of beams, wherein the beam covers a greatest number of devices of the respective devices, to produce a selected beam.

After operation 1206, process flow 1200 moves to operation 1208.

Operation 1208 depicts adding the selected beam to the group of beams.

After operation 1208, process flow 1200 moves to operation 1210.

Operation 1210 depicts removing the devices that correspond to the greatest number of devices from the group of candidate devices.

After operation 1210, process flow 1200 moves to operation 1212.

Operation 1212 depicts, in response to the group of candidate devices being determined not yet to be empty, performing another iteration of the at least one iteration.

After operation 1212, process flow 1200 moves to 1214, where process flow 1200 ends.

FIG. 13 illustrates an example process flow 1300 for statistical precoding design for initial DL transmissions, in accordance with an embodiment of this disclosure. In some examples, one or more embodiments of process flow 1300 can be implemented by system architecture 100 of FIG. 1, or computing environment 1400 of FIG. 14.

It can be appreciated that the operating procedures of process flow 1300 are example operating procedures, and that there can be embodiments that implement more or fewer operating procedures than are depicted, or that implement the depicted operating procedures in a different order than as depicted. In some examples, process flow 1300 can be implemented in conjunction with one or more embodiments of one or more of process flow 600 of FIG. 6, process flow 700 of FIG. 7, process flow 800 of FIG. 8, process flow 900 of FIG. 9, process flow 1000 of FIG. 10, process flow 1100 of FIG. 11, and/or process flow 1200 of FIG. 12.

Process flow 1300 begins with 1302, and moves to operation 1304.

Operation 1304 depicts organizing beams within the group of beams based on a first number of devices of the respective devices for which a respective beam of the beams is optimal, a second number of devices of the respective devices for which the respective beam of the beams is sub-optimal though satisfies an optimality criterion, and an indication of devices of the respective devices for which the beam corresponds to a null measurement, to produce a group of organized beams. This can comprise data arrangement as described herein.

In some examples, optimal indicates a first range of signal strength loss, sub-optimal indicates a second range of signal strength loss, and the first range is less than the second range.

After operation 1304, process flow 1300 moves to operation 1306.

Operation 1306 depicts selecting the precoding from the group of organized beams. After the data is arranged, the precoding selection can be made from the arranged data.

After operation 1306, process flow 1300 moves to 1308, where process flow 1300 ends.

### Example Operating Environment

In order to provide additional context for various embodiments described herein, FIG. 14 and the following discussion are intended to provide a brief, general description of a suitable computing environment 1400 in which the various embodiments of the embodiment described herein can be implemented.

For example, parts of computing environment 1400 can be used to implement one or more embodiments of gNB 102 and/or UEs 104 of FIG. 1.

In some examples, computing environment 1400 can implement one or more embodiments of the process flows of FIGS. 6-13 to use statistical precoding design for initial DL transmissions.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a nonvolatile storage such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and an optical disk drive 1420 (e.g., which can read or write from a CD-ROM disc, a DVD, a BD, etc.). While the internal HDD 1414 is illustrated as located within the computer 1402, the internal HDD 1414 can also be configured for external use in a suitable chassis (not shown). Additionally, while not shown in environment 1400, a solid state drive (SSD) could be used in addition to, or in place of, an HDD 1414. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can comprise one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are examples, and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1416 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
collecting respective measurements from respective user equipment that are in communication with a cell of a broadband cellular network;
determining a group of precoding matrices based on the respective measurements;
before a user equipment attaching to the cell, selecting a precoding matrix from the group of precoding matrices for initial downlink transmission with the user equipment; and
communicating with the user equipment based on the precoding matrix.

2. The system of claim 1, wherein the respective measurements comprise respective uplink control information measurements.

3. The system of claim 2, wherein the user equipment is first user equipment, wherein a second user equipment of the respective user equipment is configured to communicate with the cell via a multiple input multiple output antenna configuration, and wherein information about a single layer precoding is received from the second user equipment.

4. The system of claim 1, wherein the respective measurements comprise respective sounding reference signal measurements.

5. The system of claim 4, wherein the respective sounding reference signal measurements are collected based on channel uplink-downlink reciprocity being enabled for communications with at least some of the respective user equipment.

6. The system of claim 1, wherein the respective measurements comprise respective demodulation reference signal measurements.

7. The system of claim 1, wherein the respective measurements comprise a first combination of respective uplink control information measurements and respective sounding reference signal measurements, or a second combination of respective uplink control information measurements and respective demodulation reference signal measurements.

8. A method, comprising:
collecting, by a system comprising at least one processor, respective measurements from respective user equipment that are in communication with a cell of a broadband cellular network;
determining, by the system, a group of precoding matrices based on the respective measurements;
before a user equipment attaches to the cell, selecting a precoding matrix from the group of precoding matrices; and
based on the user equipment being determined to have attached to the cell, communicating with the user equipment using the precoding matrix.

9. The method of claim 8, further comprising:
selecting the precoding matrix from the group of precoding matrices based on setting a number of candidate precodings to one, and performing at least one iteration of,
determining whether there is a permutation of precodings with the number of candidate precodings that satisfies a coverage criterion,
based on the determining indicating that there is the permutation of precodings, using the permutation of precodings, and
based on the determining indicating that there is not the permutation of precodings, increasing the number of candidate precodings by one, and performing a subsequent iteration of the at least one iteration.

10. The method of claim 9, further comprising:
based on determining that no permutation of precodings satisfies the coverage criterion for any value of the number of candidate precodings, communicating with the user equipment using a currently-used precoding.

11. The method of claim 8, wherein the user equipment is a first user equipment, wherein the precoding matrix is a first precoding matrix, and further comprising:
updating, by the system, the respective measurements based on signs of misdetection of the respective user equipment, to produce updated measurements;
determining, by the system, a group of updated precoding matrices based on the updated measurements; and
communicating, by the system, with a second user equipment using a second precoding matrix that is selected from the group of updated precoding matrices for initial downlink transmission with the second user equipment.

12. The method of claim 11, wherein the signs of misdetection comprise a negative acknowledgment, or a discontinuous transmission indication.

13. The method of claim 8, further comprising:
periodically updating, by the system, the respective measurements, to produce updated measurements; and
updating, by the system, the group of precoding matrices based on the updated measurements.

14. The method of claim 13, wherein the periodic updating of the respective measurements is performed according to a defined time period.

15. The method of claim 13, wherein the updating is performed using an output from a trained artificial intelligence/machine learning model.

16. A non-transitory computer-readable medium comprising instructions that, in response to execution, cause a system comprising at least one processor to perform operations, comprising:
collecting respective measurements from respective devices that are in communication with a cell of a broadband cellular network;
determining a group of precoding matrices based on the respective measurements; and
communicating with a device for initial downlink transmission using a precoding matrix that is selected from the group of precoding matrices before the device attaches to the system.

17. The non-transitory computer-readable medium of claim 16, wherein selecting the precoding matrix from the group of precoding matrices is based on beginning with a group of beams set to null and a group of candidate devices set to the respective devices, and performing at least one iteration of,
selecting a beam among beams of the group of precoding matrices that are not members of the group of beams, wherein the beam covers a greatest number of devices of the respective devices, to produce a selected beam,
adding the selected beam to the group of beams,
removing the devices that correspond to the greatest number of devices from the group of candidate devices, and
in response to the group of candidate devices being determined not yet to be empty, performing another iteration of the at least one iteration.

18. The non-transitory computer-readable medium of claim 17, wherein the operations further comprise:
organizing beams within the group of beams based on a first number of devices of the respective devices for which a respective beam of the beams is optimal, a second number of devices of the respective devices for which the respective beam of the beams is sub-optimal though satisfies an optimality criterion, and an indication of devices of the respective devices for which the beam corresponds to a null measurement, to produce a group of organized beams, and
wherein selecting the beam is performed from the group of organized beams.

19. The non-transitory computer-readable medium of claim 18, wherein optimal indicates a first range of signal strength loss, wherein sub-optimal indicates a second range of signal strength loss, and wherein the first range is less than the second range.

20. The non-transitory computer-readable medium of claim 16, wherein the group of precoding matrices is a first group of precoding matrices, wherein the first group of precoding matrices is determined for a first frequency sub-band, and further comprising:
determining, by the system, a second group of precoding matrices for a second frequency sub-band.
